(19) United States
(12) Patent Application Publication
(10) Pub. No.: US 2024/0369865 A1
(43) Pub. Date: Nov. 7, 2024

(54) OPTICAL MODULATOR SEMICONDUCTOR DEVICE

(71) Applicants: Huawei Technologies Canada Co., Ltd., Kanata (CA); Universite Laval, Quebec (CA)

(72) Inventors: Abdolkhalegh MOHAMMADI, Quebec (CA); Wei SHI, Quebec (CA); Jiachuan LIN, Stittsville (CA); Leslie Ann RUSCH, Quebec (CA); Yule XIONG, Stittsville (CA)

(21) Appl. No.: 18/591,364

(22) Filed: Feb. 29, 2024

Related U.S. Application Data
(60) Provisional application No. 63/500,145, filed on May 4, 2023.

(51) Int. Cl. G02F 1/025; G02F 1/01

(52) U.S. Cl. CPC G02F 1/025; G02F 1/0102

(57) ABSTRACT

An optical modulator semiconductor device including one or more p-n junctions having a positive doped region and a negative doped region, the p-n junctions being optically connected to at least one waveguide; and an electrode assembly disposed at least partially over the at least one p-n junction, the electrode assembly comprising a first metal layer and a second metal layer, a first electrical signal pathway being formed between the two metal layers at least partially by a dielectric gap, and a second electrical signal pathway being formed by a metal contact from the electrode assembly to one of the positive doped region and the negative doped region. When in use, alternating current (AC) signals are propagated through the first signal pathway and direct current (DC) signals are propagated through the second signal pathway.

### CROSS-REFERENCE

The present application claims priority to U.S. Provisional Patent Application No. 63/500,145, entitled “Silicon Photonic Modulator Bandwidth Enhancement with Integrated Capacitance,” filed May 4, 2023, the entirety of which is incorporated by reference herein.

### FIELD OF THE TECHNOLOGY

The present invention generally relates to the field of optical networks and, in particular, to traveling-wave modulators used in optical networks.

### BACKGROUND

The development of optical transceivers with higher transmission data rates has led to the growing demand for higher modulator bandwidth. Silicon photonic components are prominent candidates for optical transceivers because of their small size, relatively low power consumption, compatibility with Complementary Metal-Oxide-Semiconductor (CMOS) technology, and low cost.

Recent advances in silicon photonic modulator structures show potential of this platform for higher bandwidth and data rate. One example of such a modulator is disclosed in the article “Segmented silicon photonic modulator with a 67-GHz bandwidth for high-speed signaling”, authored by A. Mohammadi, Z. Zheng, J. Lin, et al., published in 2022. It discloses a traveling-wave Mach-Zehnder modulator (TW-MZM) with 67 GHz bandwidth (BW) and transmission of 120-Gbaud 8-level amplitude shift keying (8-ASK, 336.4 Gb/s net).

Another recent article is entitled “240 Gb/s optical transmission based on an ultrafast silicon micro-ring modulator” authored by Y. Zhang, H. Zhang, J. Zhang, et al., and published in 2022. It discloses micro-ring modulators (MRMs) with a bandwidth of 110 GHz (using optical peaking) with 240 Gb/s 8-level pulse amplitude modulation (PAM-8).

Regarding the application of these modulator structures, TW-MZM is often a good option for broadband coherent transceivers for long-haul transmission. One of the downsides of this type of modulator is lower electro-optic modulation efficiency, often having a longer phase shifter in comparison to its peers. Having a longer phase shifter causes higher microwave attenuation and results in a lower bandwidth.

Therefore, there is a desire for a solution addressing at least some of these drawbacks.

### SUMMARY

Developers have devised methods and devices for overcoming at least some drawbacks present in prior art solutions.

An object of the present disclosure is to provide an arrangement for improving performance of an optical network. The apparatuses, methods and systems as disclosed herein aid in increasing the bandwidth of a TW-MZM without degrading its modulation efficiency.

Microwave attenuation depends on metal and dielectric loss, with the latter generally being more important. Dielectric loss is dependent on several items, including the loaded capacitance of the p-n junction. To reduce microwave loss, segmentation can be performed or the modulator structure can be engineered to have a lower loaded capacitance.

The capacitance of the junction is dependent on the p-n junction doping profile and the distribution of highly-doped and middle-doped and low-doped areas. There is a direct relation between lower capacitance and higher resistance of the junction. Having higher resistance means a lower voltage for the p-n junction capacitance causing lower modulation efficiency. Doping the area close to the p-n junction with higher dopants also causes higher insertion loss for the modulator leading to a lower optical signal to noise ratio (OSNR).

To reduce the loaded p-n junction capacitance, integrated passive capacitance can be implemented in parallel to the p-n junction to reduce the total value of loaded capacitance seen by the RF electrodes.

The disclosed technology describes silicon traveling-wave modulators with integrated distributed micro-capacitors along the modulator's electrode. An improvement lies in the utilization of effective micro-capacitors to modify the electrical properties of the modulator, thereby reducing the total capacitance loaded to the transmission line and thus reducing the microwave loss. This aids in overcoming the physical limitations that have conventionally curtailed bandwidth expansion. In at least some embodiments, this enables the modulator to achieve a bandwidth of 61 GHz, surpassing the traditional bandwidth of 45 GHz while maintaining a comparable modulation efficiency. The integration of micro-capacitors demonstrates a scalable, cost-effective approach to enhancing modulator bandwidth, offering significant benefits for optical transceiver technology in terms of data-rate, size, compatibility with CMOS processes, and economic efficiency.

Developers of the present technology have realized that in a TW-MZM, by removing at least some direct metal connections in vias through device layers connecting to the p-n junction, it is possible to implement metal-insulator-metal (MIM) passive capacitance in serial connection to the p-n junction capacitance. With this technique, the bandwidth of the modulator may, in some embodiments, be increased by more than 30% while keeping the half-wave voltage V and hence the modulation efficiency almost the same.

In the context of the present technology, “travelling-wave Mach-Zehnder modulator” (TW-MZM) refers to an optical modulator that leverages the Mach-Zehnder interferometric principle to modulate light with high-speed electrical signals. It is characterized by its travelling-wave electrode architecture, which is designed to match the velocity of the electrical modulation signal with that of the optical wave propagating through the device. The modulator manipulates the phase or amplitude of the optical signal by applying an electrical field via the electrodes, resulting in the modulation of light that is recombined at the output, enabling the encoding of data onto the light wave.

In the context of the present technology, “bandwidth” refers to the range of frequencies over which the modulator can effectively modulate an optical signal without significant signal degradation. It is one of the parameters that determines the maximum data rate that the modulator can operate with.

As used herein, the term “about” or “approximately” refers to a +/−10% variation from the nominal value. It is to be understood that such a variation is always included in a given value provided herein, whether or not it is specifically referred to.

In the context of the present technology, “half-wave voltage (V_{π})” refers to the voltage required to induce a phase shift of x radians (or 180 degrees) in the light passing through the modulator.

In the context of the present technology, “modulation efficiency” refers to the effectiveness with which the modulator converts an applied electrical voltage into an optical signal change. It is quantitatively measured by the voltage required to induce a x-phase shift in the optical signal (V_{π}), with lower values indicating higher efficiency.

In at least one aspect of the present technology, there is provided an optical modulator semiconductor device including at least one p-n junction disposed on a substrate, the at least one p-n junction comprising a positive doped region and a negative doped region, the at least one p-n junction being optically connected to at least one waveguide; and an electrode assembly disposed at least partially over the at least one p-n junction, the electrode assembly comprising a first metal layer and a second metal layer, a first electrical signal pathway being formed between the two metal layers at least partially by a dielectric gap, and a second electrical signal pathway being formed by a metal contact from the electrode assembly to one of the positive doped region and the negative doped region, when in use, alternating current (AC) signals being propagated through the first signal pathway and direct current (DC) signals being propagated through the second signal pathway.

In some embodiments, the first electrode assembly is configured to support the propagation of AC signal and the second electrode assembly is configured to support the propagation of DC signal.

In some embodiments, the at least one p-n junction includes a plurality of p-n junctions arranged in series.

In some embodiments, the dielectric gap of the first signal pathway effectively forms a capacitor using a parasitic capacitance effect.

In some embodiments, the first signal pathway includes a plurality of first signal pathways; and the second signal pathway includes a plurality of second signal pathways.

In some embodiments, at least some of the second electrical signal pathways are formed by metallic contacts forming a sub-group of first electrical signal pathways that support AC signals; the sub-group of the second electrical signal pathways is spatially distributed according to a distribution function; and the first metal layer of the electrode assembly effectively forms a resistor.

According to another aspect of the present technology, there is provided an optical modulator semiconductor device including at least one p-n junction disposed on a substrate, the at least one p-n junction comprising a positive doped region and a negative doped region, the at least one p-n junction being optically connected to at least one waveguide; a first electrode assembly disposed at least partially over the at least one p-n junction, the first electrode assembly comprising a first metal layer and a second metal layer, with a first electrical signal pathway being formed between the two metal layers at least partially by a dielectric gap, and a second electrical signal pathway being formed by a metal contact from the first electrode assembly to one of the positive doped region and the negative doped region; a second electrode assembly disposed in proximity to the first electrode assembly, the second electrode assembly comprising a third metal layer and a fourth metal layer, the two metal layers being connected via a metal contact forming a third electrical signal pathway; and an impedance element connecting the first metal layer of the first electrode assembly and the first third metal layer of the second electrode assembly forming a fourth electrical signal pathway, when in use, alternating current (AC) signals being propagated through the first and second signal pathways and direct current (DC) signals being propagated through the third and fourth signal pathways.

In some embodiments, the first electrode assembly is configured to support the propagation of AC signal and the second electrode assembly is configured to support the propagation of DC signal.

In some embodiments, the at least one p-n junction includes a plurality of p-n junctions arranged in series.

In some embodiments, for both electrode assemblies: the first metal layer is formed from a plurality of separated metal contacts; the first portion of the second metal layer is in contact with one of the plurality of separated metal contacts; and the second portion of the second metal layer is in contact with an other one of the plurality of separated metal contacts.

In some embodiments, the first signal pathway includes a plurality of first signal pathways; the second signal pathway includes a plurality of second signal pathways; the third signal pathway includes a plurality of third signal pathways; and the fourth signal pathway includes a plurality of fourth signal pathways.

In some embodiments, each one of the plurality of first signal pathways is defined through a corresponding one of the plurality of p-n junctions; each one of the plurality of second signal pathways is defined through a corresponding one of the plurality of p-n junctions; each one of the plurality of third signal pathways is defined through a corresponding one of the plurality of p-n junctions; and each one of the plurality of fourth signal pathways is defined through a corresponding one of the plurality of p-n junctions.

In some embodiments, at least some of the first electrical signal pathways are formed by metallic contacts forming a sub-group of first electrical signal pathways that support AC signals; the sub-group of the first electrical signal pathways is spatially distributed according to a distribution function; the impedance component that connects the first metal layer of the first electrode assembly and the third metal layer of the second electrode assembly forming a fourth electrical signal pathway is a resistor.

In some embodiments, each of the first electrical signal pathways are formed by dielectric gaps that support AC signals and the impedance component connecting the first metal layer of the first electrode assembly and the first third metal layer of the second electrode assembly forming a fourth electrical signal pathway includes an inductor.

According to another aspect of the present technology, there is provided an optical modulator semiconductor device including a substrate; at least one p-n junction disposed on the substrate, the at least one p-n junction comprising a positive doped portion and a negative doped portion; a first metal layer disposed at least partially over and in contact with one of the positive doped portion and the negative doped portion; and a second metal layer disposed at least partially over the first metal layer, a first portion of the second metal layer comprising a metal contact connecting the second metal layer to the first metal layer, a second portion of the second metal layer being electrically connected to the first metal layer through a dielectric gap.

In some embodiments, the first metal layer is formed from a plurality of separated metal contacts; the first portion of the second metal layer is in contact with one of the plurality of separated metal contacts; and the second portion of the second metal layer is in contact with an other one of the plurality of separated metal contacts.

In some embodiments, the at least one p-n junction includes a plurality of p-n junctions arranged in series.

In some embodiments, the dielectric gap of the second signal pathway effectively forms a capacitor using a parasitic capacitance effect.

### BRIEF DESCRIPTION OF THE FIGURES

The features and advantages of the present disclosure will become apparent from the following detailed description, taken in combination with the appended drawings, in which:

FIG. 1 depicts a travelling-wave Mach-Zehnder modulator (TW-MZM) optical device according to non-limiting embodiments of the present technology;

FIG. 2 depicts (a) an equivalent circuit of a conventional TW-MZM and (b) an equivalent circuit of the TW-MZM of FIG. 1;

FIG. 3 is a schematic, perspective view of an electrode arrangement of the TW-MZM of FIG. 1;

FIG. 4 illustrates another embodiment of a TW-MZM, in accordance with the present technology;

FIG. 5 illustrates yet another embodiment of a TW-MZM, in accordance with the present technology;

FIG. 6 illustrates yet another embodiment of a TW-MZM with no VIA2, in accordance with the present technology; and

FIG. 7 depicts an equivalent circuit of the TW-MZM of FIG. 7.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

The instant disclosure is directed to systems and apparatuses to address the deficiencies of the current state of the art. To this end, the instant disclosure describes systems and/or devices directed to increasing the bandwidth of TW-MZM without degrading its modulation efficiency, allowing for higher signal baud rate, and therefore improving throughput performance of the optical network.

The optical network equipment, as referred to herein, comprises one or more passive and/or active optical network components and/or modules of an optical network, including, but not limited to, optical fiber, optical amplifiers, optical filters, optical links, arrayed waveguide gratings, laser light sources, transmitters and receivers.

Throughout the present disclosure, the term “optical channel signal” refers to modulated optical signals at particular carrier frequencies, that is a signal that is carried in an optical link. Similarly, the term “transmitted optical channel signal” refers to an optical channel signal that is transmitted into the optical link by an optical transmitter. The term “received optical channel signal” refers to an optical channel signal, after having been propagated through the optical link, as received by an optical receiver.

Unless otherwise defined, all technical and scientific terms used herein have the same meaning as commonly understood by one of ordinary skill in the art to which the described embodiments appertain.

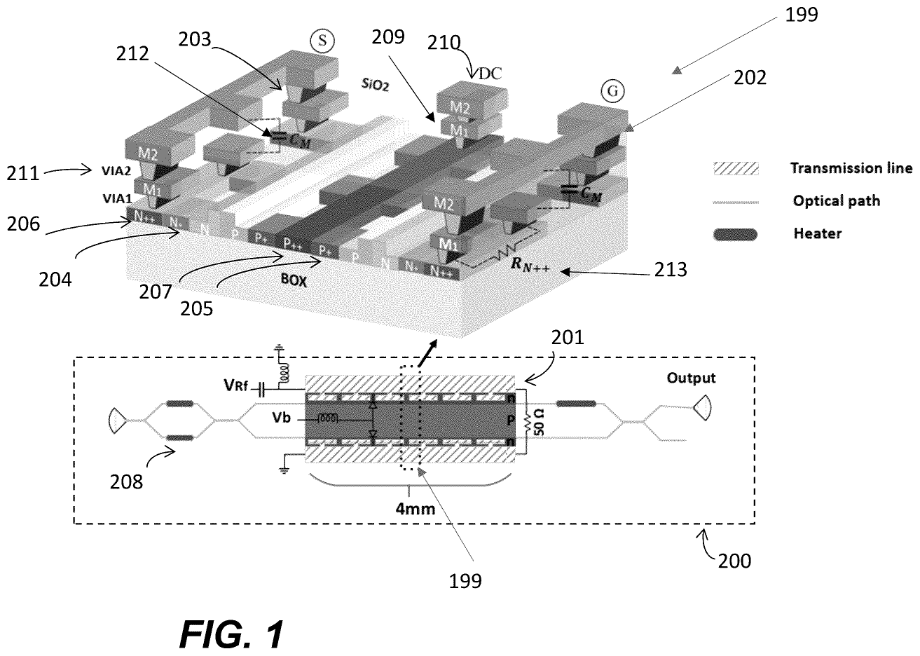

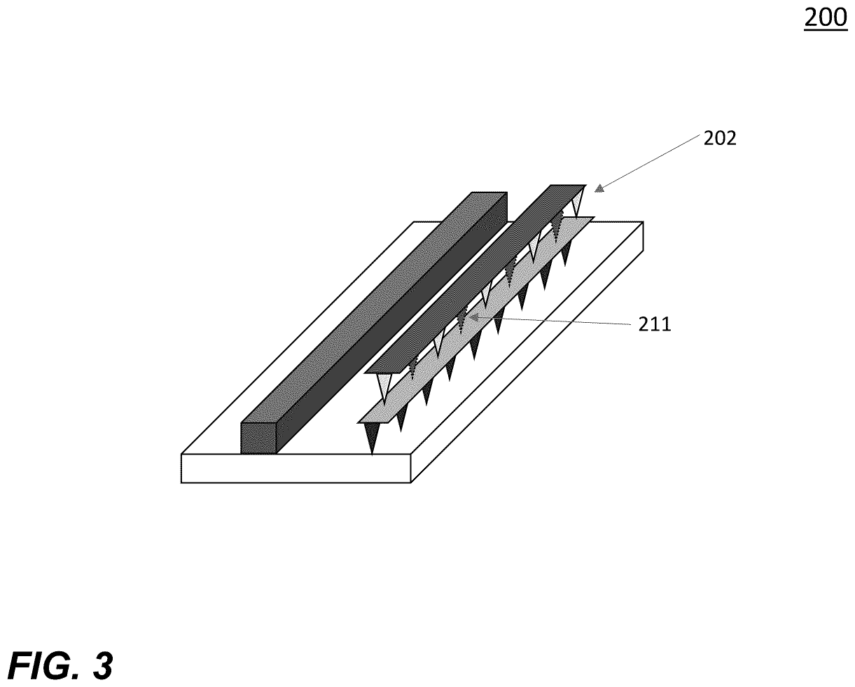

Referring now to the drawings, FIGS. 1 and 3 illustrate an optical modulator semiconductor device 200, specifically a micro-capacitor (MC) enhanced travelling-wave Mach-Zehnder modulator (TW-MZM) 200 in accordance with one non-limiting embodiment of the present technology. The modulator 200 includes two depletion-type phase shifters 201, which have a length of 4 mm and are connected in the series push-pull configuration driven by a travelling-wave (TW) electrode 202, a cross-sectional portion 199 of both of which is illustrated in a pull-out in FIG. 1. The specific size and aspect ratio could vary in different embodiments. The TW electrode 202 has a coplanar strip (CPS) structure with periodic T-shaped extensions 203 to reduce the velocity of the microwave signal to match that of the optical wave.

In the present embodiment, as observed in the cross-section 199 of the phase shifter 201, three levels of doping are used for the series of p-n junctions and are in optical communication with a silicon rib waveguide 220. The waveguides 220 are 220-nm in height in the present embodiment; other sizes and aspect ratios are also contemplated. To lower the resistance of the p-n junction for higher bandwidth, intermediate doping levels 204, 205 (N+, P+) are applied. The p-n junction and electrodes have ohmic contact by use of a highly doped levels 206, 207 (N++, P++). It is contemplated that more or fewer levels of doping could be implemented for different embodiments.

In some embodiments, at the input of the MZM 200, an adjustable coupler using two metal heaters 208 balances the input power between arms of the MZM 200 to improve the extinction ratio.

As is briefly noted above, the MZM 200 includes an electrode assembly 202 disposed at least partially over the p-n junctions. The electrode assembly 202 includes a first metal layer 209 (labeled “M1”) and a second metal layer 210 (labeled “M2”). The second metal layer 210 is disposed vertically partially over the first metal layer 209, providing a vertically arranged electrode 202.

Each of the T-shaped extensions 203 (each 47 μm in length in the present embodiment) connect the metal layers 209, 210 through a via 211 (also referred to commonly as a VIA2). In the present embodiment, metal connections are implemented in every other via 211, as is illustrated in FIG. 3 The p-n junction underneath is segmented with the same size as these T-shaped extensions. By the present technology, the vias 211 with no metal connection provide a dielectric gap between the metal layers 209, 210. These vias 211 effectively form small capacitors 212 that are connected in series with the capacitance of the junction segments. In some embodiments, experimental results indicate reduction in total loaded capacitance to about 70% of its value.

In some embodiments, additionally, the adjacent junction segments with and without the micro-capacitors in the heavily doped silicon slab (N++ and P++) are connected electrically with very low resistance 213. This assures that the p-n junction connected to the effective micro-capacitors can be effectively charged at DC and low frequencies and thus maintain the modulation efficiency.

The arrangement of the modulator 200, specifically with the electrode 202 arrangement, thus provides a first electrical signal pathway formed between the two metal layers 209, 210, separated in at least some portions by a dielectric gap. A second electrical signal pathway is formed by the metal contacts 203 disposed in the vias 211 from the electrode assembly 202 to one of the doped regions. The dielectric gaps of the first signal pathway effectively form capacitors (generally micro-capacitors) using a parasitic capacitance effect. When the modulator 200 is in use, alternating current (AC) signals are thus propagated through the first signal pathway and direct current (DC) signals are thus propagated through the second signal pathway.

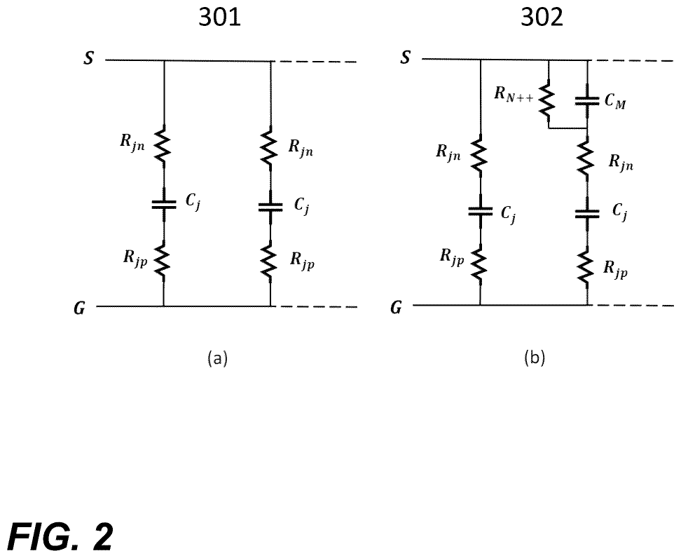

To illustrate the equivalent function of the system of FIG. 1, FIG. 2 illustrates a comparison between a typical TW-MZM and the TW-MZM 200. A representative effective circuit 301 of a typical TW-MZM is illustrated in portion (a), where the electrode thereof would be implemented using metallic connections in each via. Cⱼ, Rⱼₙ, and Rⱼₚ represent junction capacitance and resistances (in n- and p-doped silicon). Portion (b) illustrates an equivalent circuit 302 of the MC-enhanced TW-MZM 200 wherein the vias 211 are implemented using metallic connections 203 and remaining portions of the electrode 202 having dielectric gaps in the vias 211. CM and R_{N++} represent the integrated, effective vertical micro-capacitor and the resistor through the heavily doped slab respectively. The addition of C_{M} in series with Cⱼ along the TW electrode 202 reduces the total capacitance loaded to the transmission line and thus leads to a lower microwave loss and ultimately a higher bandwidth.

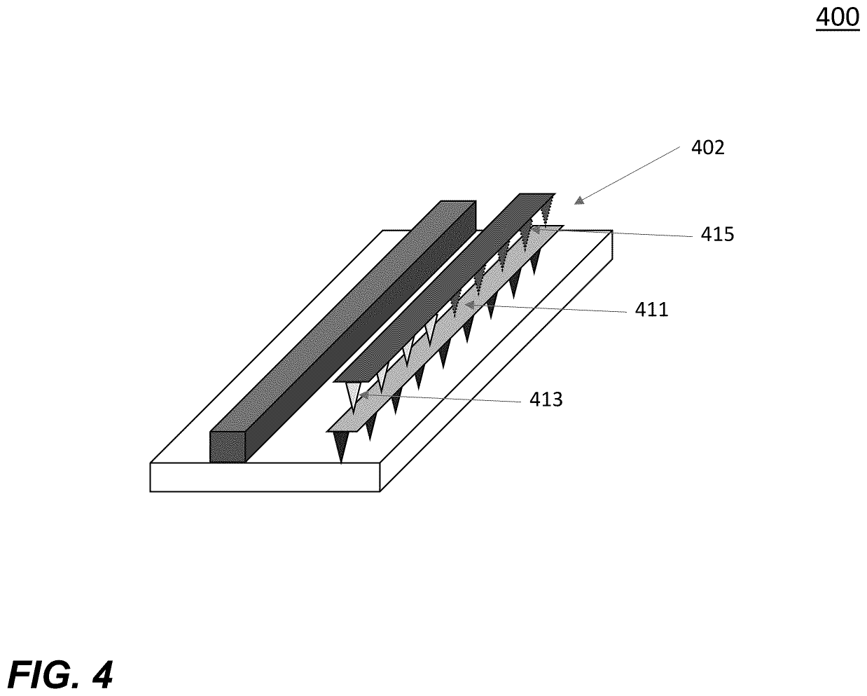

Another embodiment of a MC-enhanced TW-MZM optical device 400 according to the present technology is illustrated in FIG. 4. Elements of the device 400 that are similar to those of the device 200 retain the same reference numeral and will generally not be described again.

The modulator 400 has an electrode 402 partially formed by vias 411, similarly to the vias 211 of the modulator 200. In contrast to the alternating arrangement of the modulator 200, the two signal paths are formed by a series of neighboring metallic connections 413 through neighboring vias 411 and then a subsequent series of dielectric gaps 415.

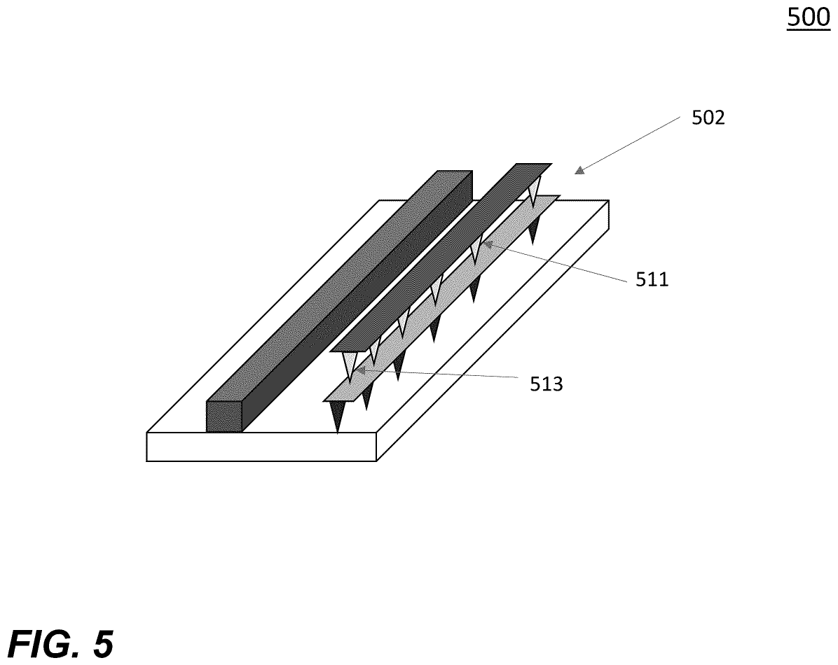

Yet another embodiment of a MC-enhanced TW-MZM optical device 500 according to the present technology is illustrated in FIG. 5. Elements of the device 500 that are similar to those of the device 200 retain the same reference numeral and will generally not be described again.

The modulator 500 has an electrode 502 partially formed by vias 511, similarly to the vias 211 of the modulator 200. In contrast to the alternating arrangement of the modulator 200, the two signal paths of the electrode 502 are formed by a series of staggered metallic connections 513 through vias 511, with the specific placement of the metallic connections 513, and the dielectric gaps (not identified) being determined by a distribution function. The particular distribution function could vary in different embodiments.

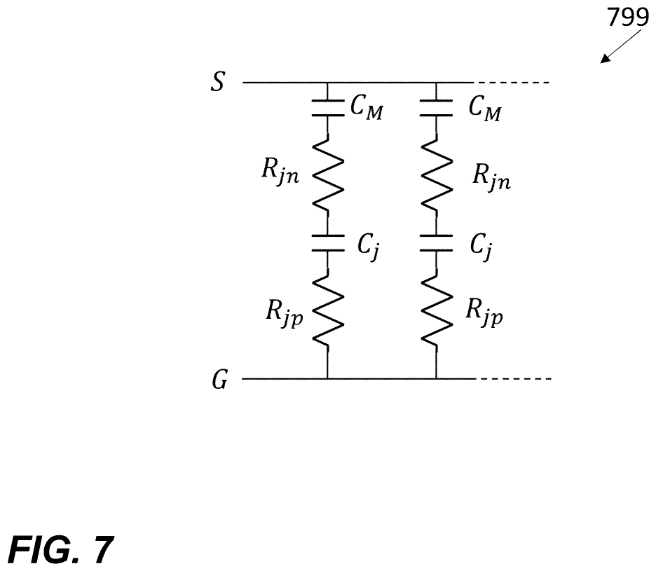

Yet another embodiment of a MC-enhanced TW-MZM optical device 700 according to the present technology is illustrated in FIG. 7. Elements of the device 700 that are similar to those of the device 200 retain the same reference numeral and will generally not be described again.

The modulator 700 includes the two metal layers, specifically M1 209 and M2 210, which form a double electrode arrangement. Each via 711 between M1 209 and M2 210 in an inner portion electrode 703 are implemented using dielectric gaps 701. A ground electrode 702 for DC (G_{DC} 702) is placed besides the inner ground electrode 703 for RF (G_{RF} 703) signals. The G_{DC} 702 is implemented by connecting the M2 layer 210 to the M1 layer 209 through metallic connections. The G_{DC} 702 further includes the M1 layer 209 of G_{DC} 702 being connected to the M1 layer 209 of G_{RF} 703. This connection is implemented through an inductor 704 to isolate RF signal. The inductor 704 may be implemented separately for each sub-segment, as is illustrated in the present embodiment. In this embodiment, the N++ regions of each sub-segment need not be connected. In some embodiments, inductor 704 may also be implemented as a lump-sum inductor on the M1 layer 209 or the M2 layer of the G_{DC} 702.

The modulator 700 is thus arranged with a first electrode assembly 703 disposed at least partially over the p-n junctions, the assembly 703 including the M1 metal layer 209 and the M2 metal layer 210. A first electrical signal pathway is formed between the two metal layers 209, 210 at least partially by a dielectric gap, and a second electrical signal pathway is formed by metal contacts from the electrode assembly 703 to the corresponding positive or negative doped region.

The modulator 700 is further arranged with a second electrode assembly 702 disposed in proximity to the electrode assembly 703. The electrode assembly 702 includes a third and fourth metal layer, generally the same two metals layers 209, 210. The metal layers 209, 210 are connected by vertically extending metal contacts. The electrode assembly 702 thus forms a third electrical signal pathway through these connections. The impedance element 704, specifically the inductor 704, connects the M1 metal layers 209 of the electrode assemblies 702, 703, thereby forming a fourth electrical signal pathway.

When in use, alternating current (AC) signals are propagated through the first and second signal pathways, through the G_{RF} 703, and direct current (DC) signals are propagated through the third and fourth signal pathways, through the G_{DC} 702.

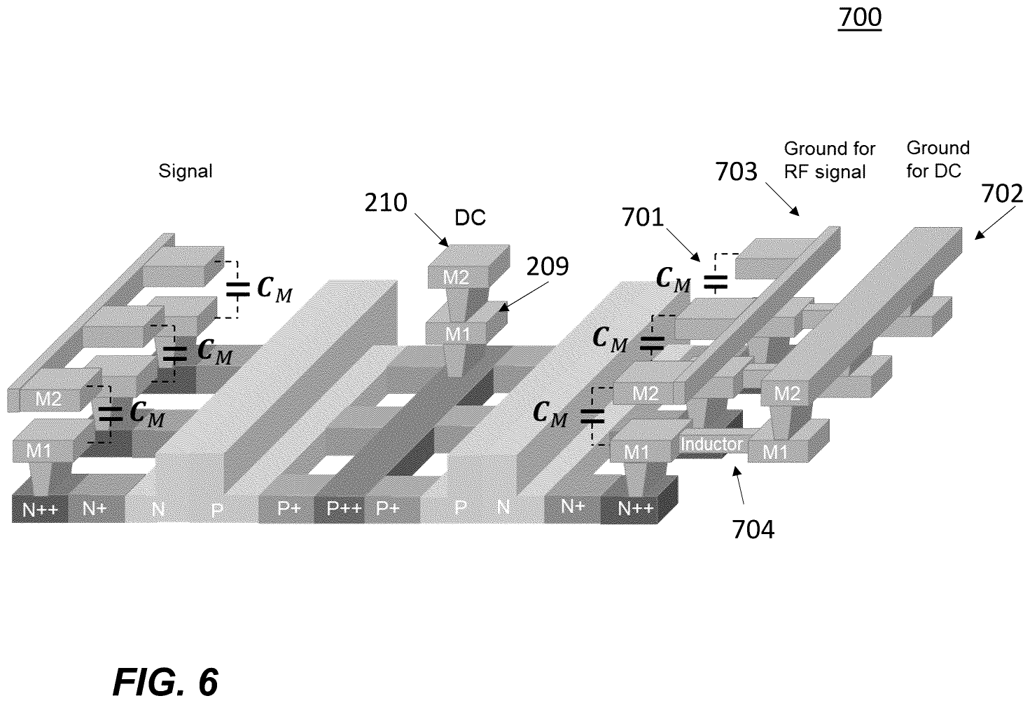

To illustrate the equivalent function of the modulator 700 of FIG. 6, FIG. 7 illustrates an equivalent circuit 799 of the MC-enhanced TW-MZM 700 wherein the vias 211 are implemented using metallic connections and remaining portions of the electrode 202 having dielectric gaps in the vais 211. C_{M} and Cⱼ represent the integrated, effective inductance and Rⱼₙ and Rⱼₚ represent the effective resistance.

One skilled in the art will appreciate that the described embodiments effectively address the issue of bandwidth limitation in a TW-MZM due to the parasitic capacitance of the p-n junctions. This is achieved by incorporating distributed micro-capacitors in connection with the p-n junctions along the TW electrode. This strategic placement of micro-capacitors helps to mitigate the adverse effects on bandwidth while preserving, if not enhancing, the modulation efficiency relative to traditional TW-MZM designs. The technology as described herein may be applied in a similar manner to optical signal transmission with any number of carriers in one optical channel.

It is to be understood that, although the inventive concepts and principles presented herein have been described with reference to specific features, structures, and embodiments, it is clear that various modifications and combinations may be made without departing from such disclosures. The specification and drawings are, accordingly, to be regarded simply as an illustration of the inventive concepts and principles as defined by the appended claims, and are contemplated to cover any and all modifications, variations, combinations or equivalents that fall within the scope of the present disclosure.

What is claimed is:

1. An optical modulator semiconductor device comprising:
at least one p-n junction disposed on a substrate, the at least one p-n junction comprising a positive doped region and a negative doped region, the at least one p-n junction being optically connected to at least one waveguide; and
an electrode assembly disposed at least partially over the at least one p-n junction, the electrode assembly comprising a first metal layer and a second metal layer,
a first electrical signal pathway being formed between the two metal layers at least partially by a dielectric gap, and
a second electrical signal pathway being formed by a metal contact from the electrode assembly to one of the positive doped region and the negative doped region,
when in use, alternating current (AC) signals being propagated through the first signal pathway and direct current (DC) signals being propagated through the second signal pathway.

2. The device of claim 1, wherein the first electrode assembly is configured to support the propagation of AC signal and the second electrode assembly is configured to support the propagation of DC signal.

3. The device of claim 1, wherein the at least one p-n junction includes a plurality of p-n junctions arranged in series.

4. The device of claim 1, wherein the dielectric gap of the first signal pathway effectively forms a capacitor using a parasitic capacitance effect.

5. The device of claim 4, wherein:
the first signal pathway includes a plurality of first signal pathways; and
the second signal pathway includes a plurality of second signal pathways.

6. The device of claim 5, wherein:
at least some of the second electrical signal pathways are formed by metallic contacts forming a sub-group of first electrical signal pathways that support AC signals;
the sub-group of the second electrical signal pathways is spatially distributed according to a distribution function; and
the first metal layer of the electrode assembly effectively forms a resistor.

7. An optical modulator semiconductor device comprising:
at least one p-n junction disposed on a substrate, the at least one p-n junction comprising a positive doped region and a negative doped region, the at least one p-n junction being optically connected to at least one waveguide;
a first electrode assembly disposed at least partially over the at least one p-n junction, the first electrode assembly comprising a first metal layer and a second metal layer, with a first electrical signal pathway being formed between the two metal layers at least partially by a dielectric gap, and a second electrical signal pathway being formed by a metal contact from the first electrode assembly to one of the positive doped region and the negative doped region;
a second electrode assembly disposed in proximity to the first electrode assembly, the second electrode assembly comprising a third metal layer and a fourth metal layer, the two metal layers being connected via a metal contact forming a third electrical signal pathway; and
an impedance element connecting the first metal layer of the first electrode assembly and the first third metal layer of the second electrode assembly forming a fourth electrical signal pathway,
when in use, alternating current (AC) signals being propagated through the first and second signal pathways and direct current (DC) signals being propagated through the third and fourth signal pathways.

8. The device of claim 7, wherein the first electrode assembly is configured to support the propagation of AC signal and the second electrode assembly is configured to support the propagation of DC signal.

9. The device of claim 7, wherein the at least one p-n junction includes a plurality of p-n junctions arranged in series.

10. The device of claim 9, wherein for both electrode assemblies:
the first metal layer is formed from a plurality of separated metal contacts;
the first portion of the second metal layer is in contact with one of the plurality of separated metal contacts; and
the second portion of the second metal layer is in contact with an other one of the plurality of separated metal contacts.

11. The device of claim 10, wherein:
the first signal pathway includes a plurality of first signal pathways;
the second signal pathway includes a plurality of second signal pathways;
the third signal pathway includes a plurality of third signal pathways; and
the fourth signal pathway includes a plurality of fourth signal pathways.

12. The device of claim 10, wherein:
each one of the plurality of first signal pathways is defined through a corresponding one of the plurality of p-n junctions;
each one of the plurality of second signal pathways is defined through a corresponding one of the plurality of p-n junctions;
each one of the plurality of third signal pathways is defined through a corresponding one of the plurality of p-n junctions; and
each one of the plurality of fourth signal pathways is defined through a corresponding one of the plurality of p-n junctions.

13. The device of claim 12, wherein:
at least some of the first electrical signal pathways are formed by metallic contacts forming a sub-group of first electrical signal pathways that support AC signals;
the sub-group of the first electrical signal pathways is spatially distributed according to a distribution function; and
the impedance component that connects the first metal layer of the first electrode assembly and the third metal layer of the second electrode assembly forming a fourth electrical signal pathway is a resistor.

14. The device of claim 12, wherein:
each of the first electrical signal pathways are formed by dielectric gaps that support AC signals; and
the impedance component connecting the first metal layer of the first electrode assembly and the first third metal layer of the second electrode assembly forming a fourth electrical signal pathway includes an inductor.

15. An optical modulator semiconductor device comprising:
a substrate;
at least one p-n junction disposed on the substrate, the at least one p-n junction comprising a positive doped portion and a negative doped portion;
a first metal layer disposed at least partially over and in contact with one of the positive doped portion and the negative doped portion; and
a second metal layer disposed at least partially over the first metal layer, a first portion of the second metal layer comprising a metal contact connecting the second metal layer to the first metal layer,
a second portion of the second metal layer being electrically connected to the first metal layer through a dielectric gap.

16. The device of claim 15, wherein:
the first metal layer is formed from a plurality of separated metal contacts;
the first portion of the second metal layer is in contact with one of the plurality of separated metal contacts; and
the second portion of the second metal layer is in contact with an other one of the plurality of separated metal contacts.

17. The device of claim 15, wherein the at least one p-n junction includes a plurality of p-n junctions arranged in series.

18. The device of claim 15, wherein the dielectric gap of the second signal pathway effectively forms a capacitor using a parasitic capacitance effect.
